(19) United States
(12) Patent Application Publication
(10) Pub. No.: US 2011/0108645 A1
(43) Pub. Date: May 12, 2011

(54) Compact Fluorescent Lamp (CFL) Recycling Machine

(76) Inventors: Edward John Domanico, Las Vegas, NV (US); Joseph DeMaria, Las Vegas, NV (US)

(21) Appl. No.: 12/613,790

(22) Filed: Nov. 6, 2009

(51) Int. Cl. B02C 23/00

(52) U.S. Cl. 241/37.5

(57) ABSTRACT

A Compact Fluorescent Lamp (CFL's) contains approximately 4.3 mg of mercury vapor. The Compact Fluorescent Lamp (CFL) Collection Apparatus is intended to provide a safe and reliable method for residential consumers to safely dispose of their spent CFL's. The apparatus looks similar to a standard size upright vending machine. It is used by residential customers at no cost. After inserting the spent CFL into the apparatus, the CFL collection process begins and the apparatus dispenses a discount product coupon to the user. This environmental health and safety incentive is courtesy of the retail store or facility owner where the Compact Fluorescent Lamp (CFL) Collection Apparatus is located.

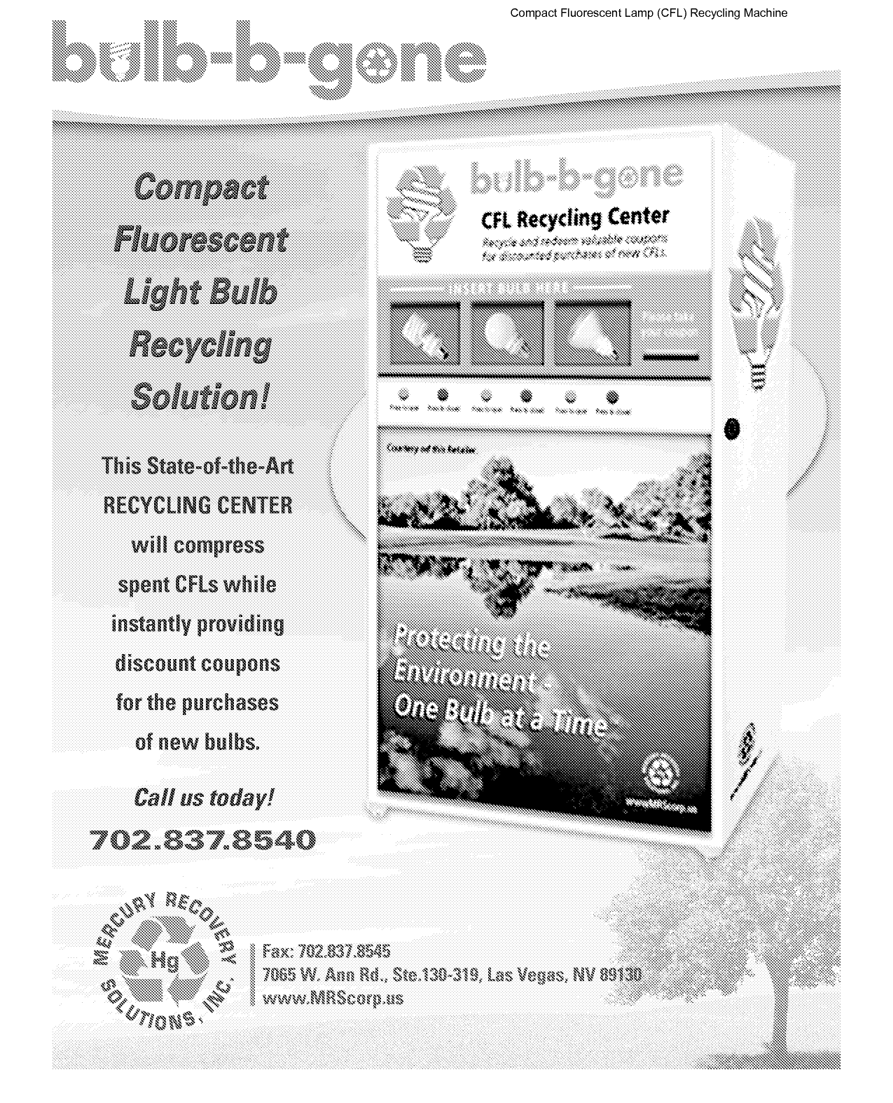

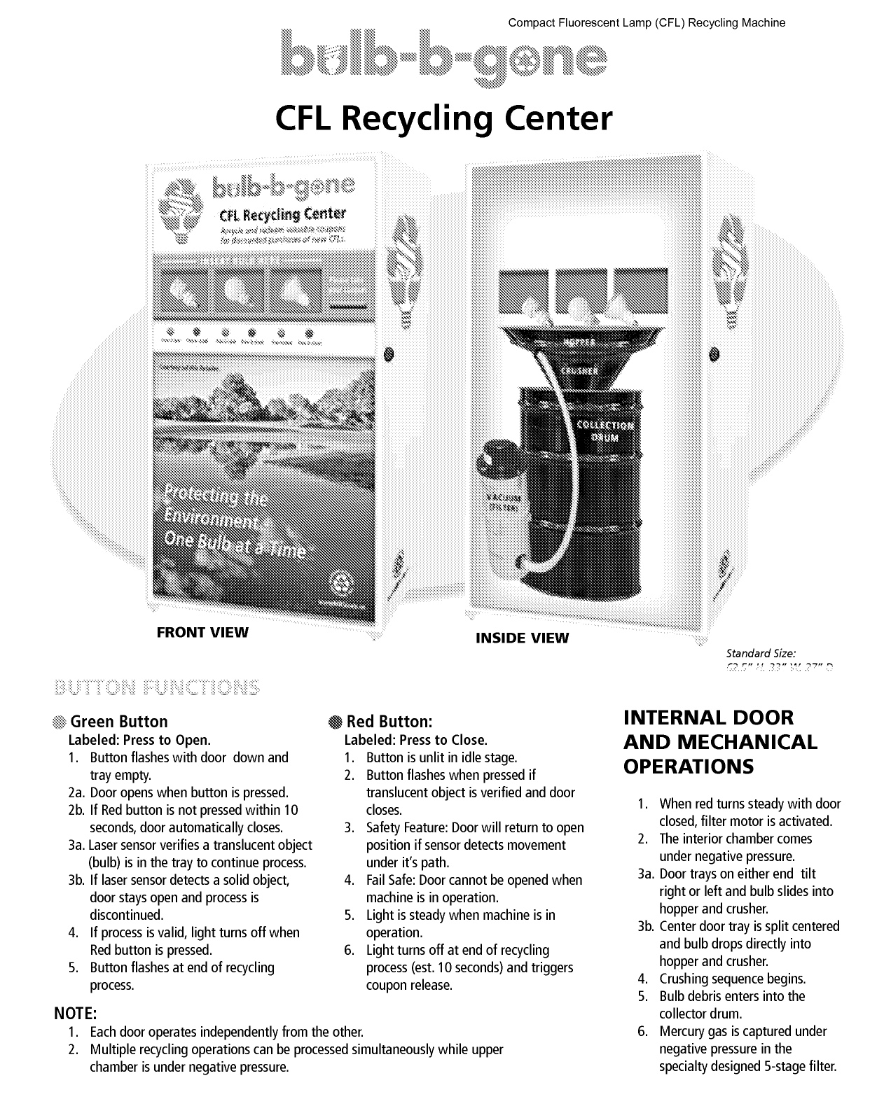

A user inserted CFL is sealed behind an airtight entry chamber under negative vacuum pressure and mechanically fed into a collection chamber to be broken by a mechanical devise. The glass and metal fragments drop into a metal collection drum below. When full, the drum is collected by a third party service company and transported to a proper and licensed recovery, treatment, or disposal facility for reprocessing. The hazardous mercury vapors are drawn into a flexible nonporous tube and into a five (5) stage mercury vacuum recovery system. The mercury vapors molecularly bond with an activated carbon media that when saturated are similarly collected by a third party service company and transported to a proper and licensed recovery, treatment, or disposal facility for reprocessing.

### CROSS-REFERENCE TO RELATED APPLICATIONS

Ser. No. 12/613,790

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATED-BY-REFERENCE OF MATERIALS SUBMITTED ON A COMPACT DISC

Not Applicable

### BACKGROUND OF THE INVENTION

The intent of this invention is to offer residential users a convenient and environmentally safe alternative to properly discard their spent Compact Fluorescent Lamps (CFL's) that would otherwise be discarded as normal household trash: When discarded in this manner, the unsuspecting public is at risk to the harmful effects of mercury vapors being released into the atmosphere from certain brakeage of CFL's during transfer to community refuse landfills. Mercury from CFL's is a potent neurotoxin. When mercury is released into the air it eventually winds up in waterways after rain, snow and dust particles wash it out of the air. Once mercury is in waterways, it's often converted into methylmercury, an organic form of mercury that builds up in fish and accumulates up the food chain. It is this methylmercury contamination that poses risks to human health and wildlife. These medical and environmental dangers can be expected to significantly increase when mass quantities of spent CFL's are not properly collected and safely disposed.

### BRIEF SUMMARY OF THE INVENTION

The Compact Fluorescent Lamp (CFL) Collection Apparatus is intended for use by residential customers (“users”) to have their spent CFL safely collected at no cost and to receive a discount coupon as a retailers reward for future CFL purchases.

### BRIEF DESCRIPTION OF THE SUBSTITUTE SPECIMEN SHEET (DRAWING)

The specimen sheet titled Compact Fluorescent Lamp (CFL) Collection Apparatus (drawing) is two pages in length. The first page shows the front view of the Apparatus as described in paragraph [0004]. The second page depicts the interior of the apparatus' four main components, (1) CFL bulb entry compartment; (2) mechanical collection device; (3) collection drum; and (4) the mercury vacuum recovery system, as described in paragraph [0004].

### DETAILED DESCRIPTION OF THE INVENTION

The Compact Fluorescent Lamp (CFL) Collection Apparatus is the size of a standard upright vending machine. Residential customers (“users”) bring their spent Compact Fluorescent Lamps (CFL's) to be safely collected by this apparatus. The apparatus is designed to be internally airtight when in operation to safely collect and mechanically break the CFL. The apparatus works under a negative pressure vacuum that separates the glass and metal debris from the harmful mercury vapors of the CFL during the breaking process. The glass and metal debris drop into a 30 U.S. gallon (or similar size) steel drum container and is classified as “universal waste.” The mercury vapors are simultaneously captured under negative pressure through a nonporous flexible inlet hose connected to a five (5) stage mercury vacuum recovery system. The captured mercury will be safely collected by a third party service company when the filters become saturated and taken to a certified recycling facility for processing, likewise with the collection drum when it reaches its holding capacity. During the collection process, the apparatus dispenses a discount coupon to the user courtesy of the retailer towards additional purchases.

The apparatus is internally airtight when in operation. It has four major components. (1) CFL bulb entry compartment; (2) mechanical collection device; (3) collection drum; and (4) the mercury vacuum recovery system. The apparatus has three (3) colored LED's on the face of the unit that offer visual cues of the apparatus' operational status. Green LED labeled “Ready”; Yellow LED labeled “Service”; and Red LED labeled “Full”. As a safe-guard, the Red LED will also illuminate and lockout the apparatus when any component of the apparatus has malfunctioned and/or the collection drum and any of the vacuum filters have reached their maximum collection capacities.
a) CFL bulb entry collection compartment. This compartment is top-hinged, spring to close and an electrically lockable entryway. The compartment is in the open position when the apparatus in a stand-by mode and the Green LED illuminated and ready for the use.
b) CFL bulb entry collection compartment is at an ADA compliant height of no more than 45″ inches from the ground.
c) Photo-optic safety sensors located inside this compartment act as a fail-safe mechanism that will not permit operation if the sensors detect something other than a CFL bulb, such as a hand or other non lamp object.
d) User places the anode base of their spent CFL inside a reciprocal anode bulb base. This fail-safe functions as a detection mechanism wherein electrical continuity will be completed when the CFL anode base is correctly placed into the reciprocal anode bulb base and makes a positive electrical connection.
e) The CFL bulb entry collection compartment door is electrically closed and locked when all fail-safes have been satisfactorily achieved.
f) The internal mercury vacuum recovery system is activated upon successful closure and locking of the CFL entry collection compartment door. The vacuum motor creates an immediate negative pressure and airtight seal of major internal collection components with an 88″ inch Water Column static lift at 95 cubic feet per minute.
g) The internal collection components and gaskets within the apparatus become sealed under negative pressure vacuum to prevent any possible leakage of mercury vapors back into the environment from the apparatus collection process.
h) The Green LED turns off during CFL collection process.
i) The front panel of the apparatus is equipped with a programmable coupon generator module equipped with a thermal printer located at an ADA compliant height of no more than 45″ inches from the ground. The printer dispenses a discount coupon to the user.
j) CFL bulb entry compartment shelf rotates approximately 180 degrees towards the interior of the apparatus to release the CFL to be gravity fed into an angled and sealed duct to arrive into the mechanical collection device chamber.
k) The mechanical collection device chamber contains a horizontally mounted and motorized chain-driven auger, centered below the angled duct and operated under low torque to break the CFL bulb into small pieces.
l) The auger is centered over two (2) hinged, gasketed and motor actuated trap doors that will mechanically open upon several revolutions of the auger process.
m) Collection drum. Glass and metal debris from the broken CFL bulb drop from the trap doors into a 30 U.S. gallon (or approximate size) metal collection drum centered below the two (2) hinged trap doors.
n) The mechanical collection device chamber also contains a 1″ inch diameter by 1″ inch long welded nipple to accept the inlet hose from the mercury recovery vacuum filter assembly
o) Mercury vapors released from the broken CFL are drawn through the 1″ inch diameter inlet nipple under negative pressure and into a nonporous flexible hose connected to a five (5) stage mercury vacuum recovery system.
p) The mercury vacuum recovery system contains one six (6) U.S. gallon stainless steel tank, operating on 120/220 VAC, 50/60 Hz and capable of an 88″ water column (WC) and static lift at 95 cubic feet per minute (CFM).
q) The mercury vacuum recovery system contains five (5) filters: (1) disposable vacuum bag; (2) Dacron filter bag; (3) Micro impact filter; (4) HEPA filter 99.7% @0.3 micron; and (5) High capacity filter module containing 10 lbs. of activated 4.00 mm pelletized coal base sul-impregnated carbon that captures and molecularly bonds the free mercury during the CFL collection process.
r) Clean air is exhausted out the top of the mercury vacuum recovery system via a flexible nonporous hose and vented out the back of the apparatus.
s) A mechanical collection use counter will register each use of the apparatus to assist in servicing the collection drum when full and the periodic replacement of vacuum filters.
t) The mechanical collection use counter will also trigger and illuminate the Yellow LED (“Service”) on the face of the apparatus and/or transmit a wi-fi remote message to a third party collection company when individual components of the mercury vacuum recovery system and collection drum are near capacity and require servicing, replacement or to repair an internal malfunction.
u) The apparatus will continue to function while the Yellow LED (“Service”) is illuminated until such time as the mechanical collection counter reaches a predetermined number that signifies an internal collection component has reached its maximum collection capacity. At that time the Red LED (“Full”) illuminates on the face of the apparatus, a programmed fail-safe mode is triggered preventing the apparatus from returning to operational status until servicing of the apparatus has been completed and the machine motor controller is reset.

1. We reaffirm and claim that the “Compact Fluorescent Lamp (CFL) Collection Apparatus” subject matter described and listed in the substitute specification and shown in the accompanying specimen sheet drawings, we regard as our invention and are distinctive in scope, application and design. A paragraph briefly describing the specimen sheet (drawing) has been added to the Specification sheet. All errors corrected in this reissue application arose without any deceptive intention on the part of the applicants.
